(19) United States
(12) Patent Application Publication
(10) Pub. No.: US 2004/0177675 A1
(43) Pub. Date: Sep. 16, 2004

(54) Gas gage utilizing internal resonance frequency

(76) Inventor: Gardner P. Wilson, Pasadena, CA (US)

Correspondence Address: GARDNER P. WILSON, 587 S. HILL AVE., PASADENA, CA, 91106, US

(21) Appl. No.: 10/386,467

(22) Filed: Mar. 12, 2003

(51) Int. Cl. G01B 13/08

(52) U.S. Cl. 73/37.5

(57) ABSTRACT

An instrument for measuring a gap between it and an imposing surface comprising a gas conduit having an inlet and an outlet, a sensing orifice, a gas pump connected to the inlet for applying an alternating pressure to the gas conduit so that the puffs of gas are directed from and back to the sensing orifice. The timing frequency rate is determined by the adding of a new dimension to the well-known Helmholtz resonance frequency parameters when used as feedback to an amplifying-oscillator circuit. This frequency pitch rather than its amplitude is now used to determine the gap distance, and this frequency can be perfectly transmitted to eternal observers. This frequency pitch can be counted over longer periods of time to improve its sensitivity and minimize system noise.

### FIELD OF INVENTION

This invention is related to gas gages useful in measuring the space of a probe tip to a surface without touching that surface. This space is commonly called a “gap”, and because the gas commonly used is air, these devices are thought of as “air gages”.

### BACKGROUND OF THE INVENTION

There are many applications for non-contact gages which can measure the size of a gap between its probe tip and a working surface. The general principle is that a gas jet can be partially blocked by the presence of an object or surface. The percentage of blocking is roughly inversely proportional to the distance of the probe tip to the surface. Conventionally, the amplitude of pressure variations created by this partial blocking are read as the size of the gap, as shown by WILSON U.S. Pat. No. 4,142,401 and WILSON U.S. Pat. No. 5.022,258 and many earlier concepts.

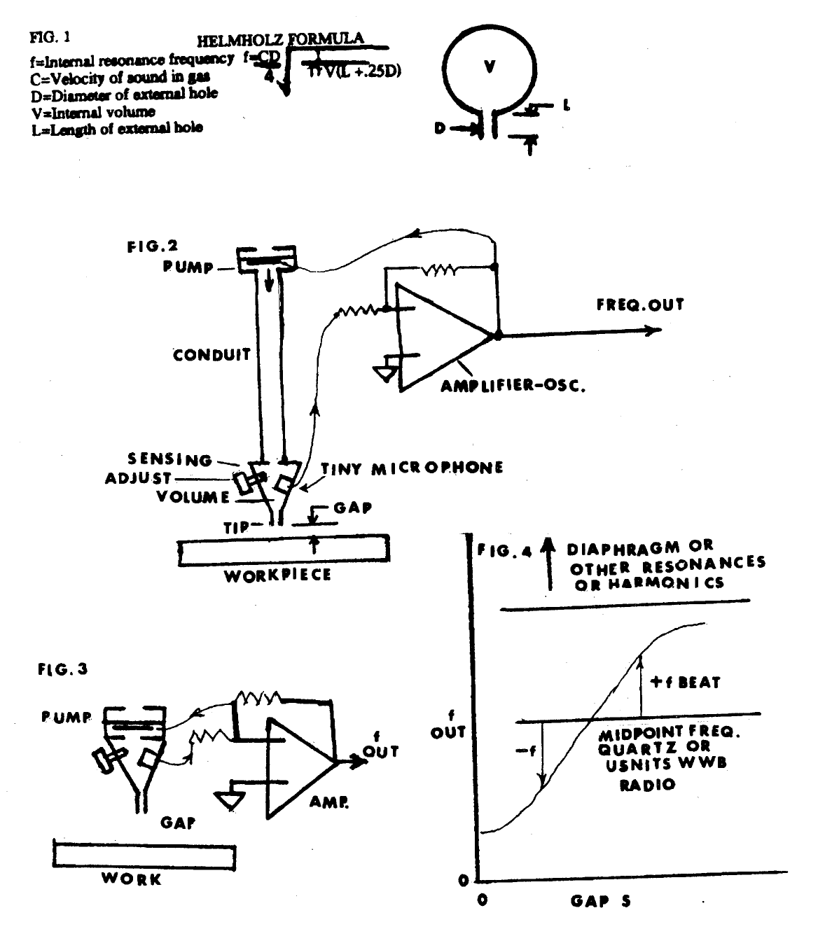

This invention is based on the adding of a new parameter to the classical provisions of the past scientist Herman von Helmholtz of Germany, who studied the behavior of the internal frequency resonance of cavities having an external hole that communicated to the space around them. He listened to the internal frequency of blown glass spheres and came up with the following general formula shown in FIG. 1. This formula has been useful for the design of musical instruments, sound generators and speakers and buzzers, and auditoriums.

This invention's new parameter S, which is the distance externally from the probe tip to the workpiece, has been added to Helmholtz's observations of internal resonance frequency of the cavity when used as feedback to an amplifier-oscillator circuit shown in FIG. 2 The system is made to oscillate at a frequency that varies over a wide range of better than ten-to-one, which can be transmitted with great precision.

One of the most significant objects of this invention is to provide an instrument which does not introduce particulates into clean room environments.

Another object is to make measurements considerably smaller than one millionth of an inch using very low amounts of energy and minimal thermal effects on the workpiece. These microinch or micron measurements can be made under human-compatible conditions not requiring a vacuum system.

### A BRIEF DESCRIPTION OF THE INVENTION

Refering to FIG. 2, the pump can be piezoelectric, magnetic or other. Its purpose is to send varying frequency pulses down the conduit to the sensing assembly where they can enter volume V. In this volume is placed a tiny microphone whose signals are sent to the amplifier-oscillator as feedback, and whose amplified output drives the pump diaphragm. This output frequency can be transmitted to the observer for digitizing and driving an audible variable frequency tone generator.

The pitch frequency of the output tone can be compared with a precision quartz crystal clock or to the US NIST BUREAU OF STANDARDS radio transmissions.

It is feasible to add a tiny screw or adjustment to vary volume V, diameter D or length L, to correct for temperature or other variations.

The resonance frequency of volume V can be counted over longer periods of time to minimize system noise errors.

Care should be taken to avoid diaphragm or other internal resonances that occur at a frequency within the operating range of the instrument. These internal frequencies and their harmonics should be set to greater than the operating range of the instrument where they will not interfere.

Other means to determine volume V resonance can be utilized without the use of the tiny microphone. Volume V can be used directly as a circuit element.

The length of the conduit from the pump to the sensing assembly may be varied down to zero by placing the pump directly onto volume V, depending upon the user's needs.

The above Helmholtz frequency will be reduced by the presence of a workpiece, and will be minimum when the hole is closed. The maximum frequency will occur when S is at infinity, and it is finite, as shown in FIG. 4.

I claim:

1. An instrument for measuring a gap between it and an opposing surface composing a vibrating diaphragm pump connected to a volume containing a sensing orifice directed toward the gap facing the surface to be measured. The vibrating frequency of this pump is determined by its volume's ability to charge and discharge itself in the gap with each cycle. This feedback frequency is sensed with electronic amplification and is presented to the observer as a measurement of that gap, and may have a frequency variation of better than ten-to-one.

2. An instrument according to claim 1 whose vibrating frequencies between gap distances from zero to infinity are not interfered with by other resonances in the instrument's makeup, such as ringing diaphragms. Those frequencies and their harmonics are designed to be above those generated by the variations of the gap being measured.

3. An instrument according to claim 1 which utilizes a tiny adjustment of the volume V, diameter D or length L, to correct for variations in frequency generated by temperature or other effects when used for measuring a known standard gap. This frequency can be compared with the frequencies generated by the US NIST radio transmissions, a real time clock oscillator or a local quartz crystal oscillator, thus assuring high system accuracy.

4. An instrument according to claim 1 whose variations in internal resonance frequency are digitally or audibly displayed as non-contact gap dimensions in English or Metric numbers. It is feasible to design a system whose frequency difference with a quartz crystal frequency standard is one hertz per millionth of an inch gap variation, or one hertz per micron, or one hertz per nanometer, so the operator can make proper correction to error just by listing.
